(19) United States
(12) Patent Application Publication
(10) Pub. No.: US 2005/0060363 A1
(43) Pub. Date: Mar. 17, 2005

(54) Over-the-air provisioning of a mobile station for multi-media service

(76) Inventors: Ke-Chi Jang, Plano, TX (US); Marvin Bien, Dallas, TX (US); Chung-Ching Wang, Plano, TX (US)

Correspondence Address: GARLICK HARRISON & MARKISON LLP, P.O. BOX 160727, AUSTIN, TX, 78716-0727, US

(21) Appl. No.: 10/881,272

(22) Filed: Jun. 30, 2004

Related U.S. Application Data
(60) Provisional application No. 60/502,538, filed on Sep. 12, 2003.

(51) Int. Cl. H04Q 7/24; G06F 15/16

(52) U.S. Cl. 709/200; 370/338

(57) ABSTRACT

Operating a cellular wireless communication network to configure a mobile station to support a Multi-Media Service (MMS). Operation includes determining that configuration of the mobile station for the MMS is required. A plurality of components of the cellular wireless communication network are provisioned for configuring the mobile station, the plurality of components of the cellular wireless communication network including an Over-The-Air-Function (OTAF). The mobile station is then located, e.g., serving MSC, BSC, and base station are determined. Then, a wireless communication link with the mobile station via a servicing base station is established. Communications between the OTAF and the mobile station are then established via a combination of a wired path of the cellular wireless communication network and the wireless communication link. The OTAF then communicates with the mobile station to program at least one MMS Uniform Resource Identifier (URI) within the mobile station.

### CROSS REFERENCE TO RELATED APPLICATION

This application claims priority to U.S. Provisional Patent Application Ser. No. 60/502,538, filed Sep. 12, 2003, which is incorporated herein by reference for all purposes.

### BACKGROUND OF THE INVENTION

1. TECHNICAL FIELD OF THE INVENTION

This invention relates generally to cellular wireless communication systems and, more particularly, to the configuration of mobile stations by a cellular wireless communication system.

2. Description of Related Art

The structure and operation of cellular wireless communication systems is generally known. A cellular network infrastructure typically includes a plurality of base stations that each service wireless communications for one or more cellular mobile stations within a respective cell. Typically, each base station supports a plurality of sectors within its serviced cell. Base Station Controllers (BSCs) typically service a plurality of base stations and coordinate operations within the cells serviced by the base stations. A mobile switching center (MSC) services a plurality of base station controllers and couples to the Public Switched Telephone Network (PSTN). Typically, the base station controllers or the MSC couple to the Internet to service packetized communications there through.

Cellular wireless infrastructures typically support one or more wireless protocol standards. These wireless protocol standards include Code Division Multiply Access (CDMA) protocol standards such as IS-95A, IS-95B, 1X-RTT, 1xEV-DO, 1xEV-EV, UMTS, and other CDMA type protocols. Alternately, the wireless protocol standard may service a Time Division Multiple Access (TDMA) standard such as the GSM standard, the North American TDMA standard, or other TDMA standards. The cellular mobile stations operating in the service area communicate with the base stations using such supported wireless protocol standards.

Cellular wireless communication service providers, as well as Internet service providers, are increasingly working together to support packetized services for subscribing mobile stations. Text messaging services, Internet browsing, some Voice over Internet Protocol (VoIP) services, and Video conferencing are examples of data/voice/video services now currently available to mobile stations. To provide these services, the cellular network infrastructure typically operates in cooperation with one or more servers coupled to the cellular wireless communication network via the Internet or an Intranet. These packet switched networks typically use the Internet Protocol (IP) and supporting protocols to service packetized communications between the mobile station and the server.

In supporting these services, the mobile station must establish communications with the server. The cellular wireless network supports IP communications between the mobile station and the Internet/Intranet. The mobile station uses this IP communication link to access the server. However, prior to establishing communications with the server, the mobile station must be provisioned so that is possesses information required to communicate with the server. Such provisioning typically includes programming the mobile station with a Uniform Resource Identifiers (URI) that corresponds to server. The mobile station uses the URI to obtain an IP address (or addresses) from a Domain Name Server (DNS) that it uses to access the server.

Heretofore, provisioning of the mobile station with such URI(s) involved programming by either the subscriber or by an employee/agent of the cellular wireless network to which the mobile station is subscribed. Such programming was tedious, time consuming, and prone to errors. Further, because the programming was static, and changes to the subscription or the server require a reprogramming of the mobile station. Therefore, a need exists for improvements in programming of the mobile station.

### BRIEF SUMMARY OF THE INVENTION

In order to overcome the above-described shortcomings, among others, a method for operating a cellular wireless communication network configures a mobile station to support a Multi-Media Service (MMS). The method includes first determining that configuration of the mobile station for the MMS is required. This may occur during an Over-The-Air-Service-Provisioning (OTASP) operation or during an Over-The-Air-Parameter-Administration (OTAPA) operation. The method continues with provisioning a plurality of components of the cellular wireless communication network for configuring the mobile station, the plurality of components of the cellular wireless communication network including an Over-The-Air-Function (OTAF). The mobile station is then located, e.g., serving MSC, BSC, and base station are determined. Then, the method includes establishing a wireless communication link with the mobile station via a servicing base station. Communications between the OTAF and the mobile station are then established via a combination of a wired path of the cellular wireless communication network and the wireless communication link. The OTAF then communicates with the mobile station to program at least one MMS Uniform Resource Identifier (URI) within the mobile station.

According to embodiments of the present invention, the MMS includes at least one of multimedia messaging services, instant messaging services, web browsing services, audio conferencing services, and audio/video conferencing services. The method may further include receiving a Multi-Media Service (MMS) request that includes the URI that is programmed within the mobile station, forwarding the MMS request to an Internet Protocol (IP) network, a Domain Name Server (DNS) of the IP network servicing the MMS request to determine the IP address of a server that will service the MMS request, forwarding the MMS request to the server at the IP address, and the server servicing the MMS request and providing the service to the mobile station.

In one particular embodiment, the OTAF communicating with the mobile station to program at least one URI within the mobile station includes the servicing base station sending an MMS configuration request message to the mobile station and the servicing base station receiving an MMS configuration response message from the mobile station. In such embodiment, the MMS configuration request message may include a requested number of MMS parameter blocks and, for each of the requested number of MMS parameter blocks, an MMS parameter block identifier.

In the particular embodiment, the MMS configuration response message includes a reported number of MMS parameter blocks and, for each of the reported number of MMS parameter blocks an MMS parameter block identifier, an MMS parameter block length, and MMS parameter block data. The MMS parameter block data may include a corresponding number of MMS URIs and, for each the corresponding number of MMS URIs, a MMS URI entry index, a MMS URI length, and a MMS URI.

In another particular embodiment, the OTAF communicating with the mobile station to program at least one URI within the mobile station includes the servicing base station sending an MMS download request message to the mobile station and the servicing base station receiving an MMS download response message from the mobile station. With this embodiment, the MMS download request message may include an included number of MMS parameter blocks and, for each of the included number of MMS parameter blocks, an MMS parameter block identifier, an MMS parameter block length, and MMS parameter block data. The MMS parameter block data may include a corresponding number of MMS URIs and, for each the corresponding number of MMS URIs, a MMS URI entry index, a MMS URI length, and a MMS URI.

With this other particular embodiment, the MMS download response message may include a reported number of MMS parameter blocks and, for each of the reported number of MMS parameter blocks, an MMS parameter block identifier, an MMS parameter block length, and MMS parameter block data. The MMS parameter block data may include a corresponding number of MMS URIs and, for each the corresponding number of MMS URIs, a MMS URI entry index, a MMS URI length, and a MMS URI.

In various embodiments, determining that configuration of the mobile station for the MMS is required occurs when the cellular wireless communication network determines that MMS for the mobile station has changed, the cellular wireless communication network determines that a server providing the MMS for the mobile station has been altered, or the cellular wireless communication network determines that a MMS provisioning threshold for the mobile station has been met.

The above-referenced description of the summary of the invention captures some, but not all, of the various aspects of the present invention. The claims are directed to some of the various other embodiments of the subject matter towards which the present invention is directed. Other aspects, advantages, and novel features of the invention will become apparent from the following detailed description of the invention when considered in conjunction with the accompanying drawings.

### BRIEF DESCRIPTION OF THE SEVERAL VIEWS OF THE DRAWINGS

FIG. 1 is a system diagram illustrating a portion of a cellular wireless communication network constructed and operating according to the present invention;

FIG. 2 is a flow chart illustrating a first embodiment of a method of the present invention;

FIG. 3 is a flow chart illustrating operations according to another aspect to the present invention;

FIG. 4 is a combination flow chart and block diagram illustrating a particular embodiment of the present invention; and

FIG. 5 is a combination flow chart and block diagram illustrating another particular embodiment of the present invention.

### DETAILED DESCRIPTION OF THE INVENTION

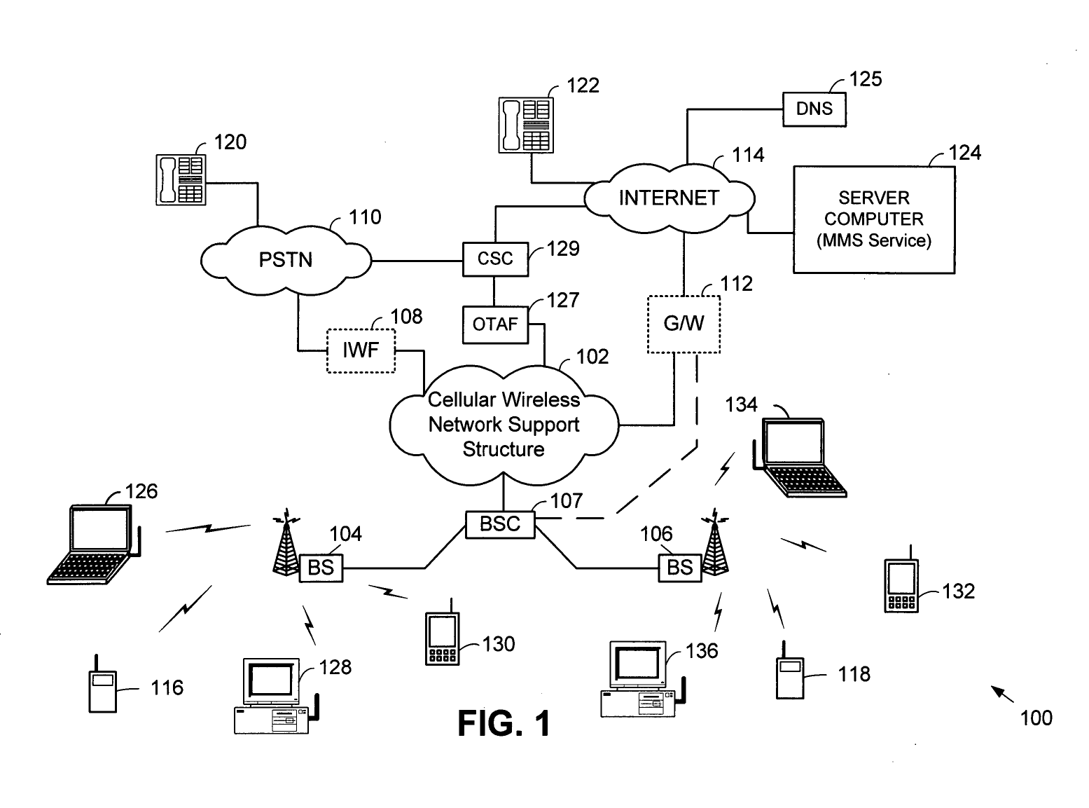

FIG. 1 is a system diagram illustrating a portion of a cellular wireless communication network 100 constructed and operating according to the present invention. The cellular wireless communication network 100 includes a cellular wireless network support structure 102, base station controller (BSC) 107, base station 104, and base station 106. The cellular wireless communication network 100 operates according to one or more protocol standards, e.g., IS-95A, IS-95B, 1xRTT, 1xEV-DO, 1xEV-DV, GSM, UMTS, TDMA, AMPS, ANSI-41, etc. The cellular wireless communication network 100 also supports Over-The-Air-Service-Provisioning (OTASP) provisioning operations, e.g., ANSI-683, and Over-The-Air-Parameter-Administration (OTAPA) operations according to the present invention. Note that the operations of the present invention may require modification of some aspects of its supported protocol standard(s).

The cellular wireless network support structure 102 couples to the Internet 114. The cellular wireless network support structure 102 also couples to the Public Switched Telephone Network (PSTN) 110. In one embodiment of the present invention, the cellular wireless network support structure 102 is circuit switched, couples directly to the PSTN 110, and couples to the Internet 114 via a gateway (G/W) 112. In another embodiment of the present invention, the cellular wireless network support structure 102 is packet switched, couples directly to the Internet 114, and couples to the PSTN via an interworking function (IWF) 108. The cellular wireless network support structure 102 includes at least one Mobile Switching Center (MSC)/Mobile Telephone Exchange (MTX), at least one Home Location Register (HLR), at least one Visitor Location Register (VLR), and other components that support the cellular wireless network 100.

Cellular mobile stations 116, 118, 126, 128, 130, 132, 134, and 136 wirelessly couple to the cellular wireless communication network 100 via wireless links with the base stations 104 and 106. As illustrated, cellular mobile stations may include cellular telephones 116 and 118, laptop computers 126 and 134, desktop computers 128 and 136, and data terminals 130 and 132. However, the wireless network supports communications with other types of cellular mobile stations as well.

Each of the base stations 104 and 106 services a cell/set of sectors within which it supports wireless communications. Wireless links with the cellular mobile stations 116-136 include the forward link (transmissions from a serving base station to a serviced cellular mobile station) and the reverse link (transmissions from the serviced cellular mobile station to the serving base station). The forward and reverse links support voice communications and data communications. The teachings of the present invention apply equally to any type of cellular wireless communication.

Each of mobile stations 116-136 is capable of servicing Multi-Media Services (MMSs). In order to support MMSs, the mobile stations 116-136 must be programmed according, e.g., have information regarding a servicing device such as server computer 124. As is generally known, in order to access a server computer 124 via the Internet 114, a requesting device, e.g., mobile station 116, must have the Internet Protocol (IP) address of the server computer 124. In one typical methodology for obtaining an IP address, the requesting mobile station 116 has a Uniform Resource Identifier (URI) for the server computer 124. In initiating a service access, the mobile station 116 sends an IP packet to the Internet 114 via the cellular wireless communication network 100 that is addressed to Domain Name Server (DNS) 125. This IP packet includes the URI for the server computer 124. The DNS 125 returns an IP address of the server computer 124 to the mobile station 116. The mobile station 116 then uses this IP address to access the server computer 124 and to obtain MMS there from.

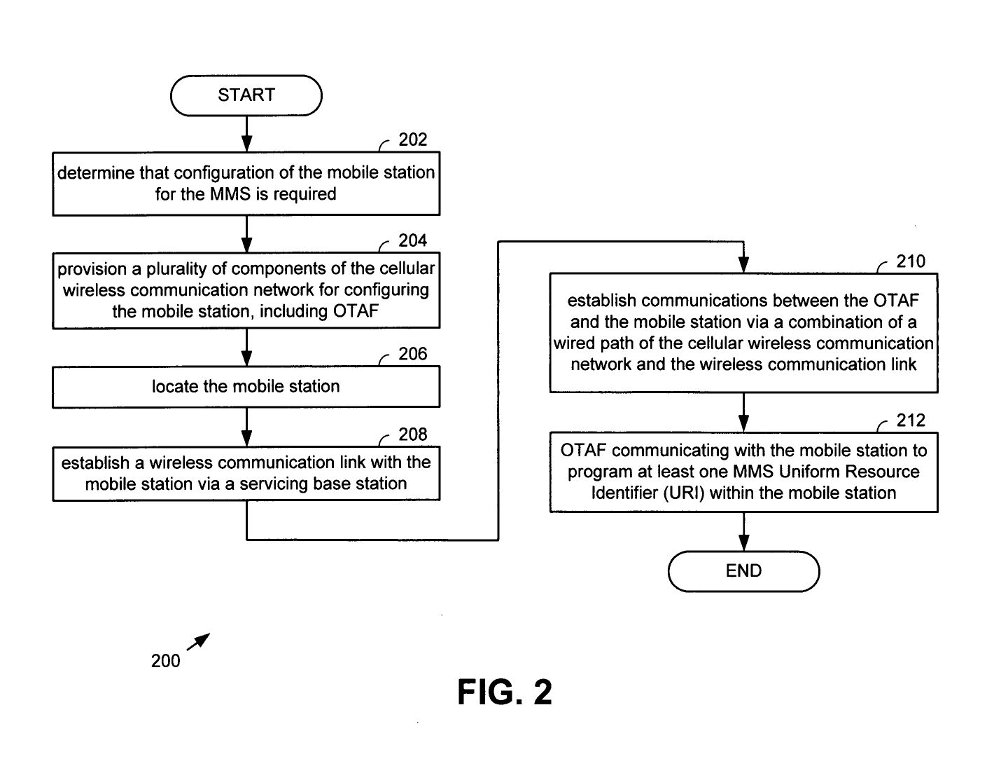

According to the present invention, the cellular wireless communication network 100 configures the mobile station 116 for the MMS. The structure of the cellular wireless communication network 100 that performs such configuration includes a Customer Service Center (CSC) 129, an Over-The-Air-Function (OTAF) 127, the cellular wireless network support structure 102, a servicing BSC 107, and a servicing base station 104. A servicing MSC and other allocated resources of the cellular wireless network support structure 102 also support configuration of the mobile station 116 for MMS. One particular operation for configuring a mobile station is described in detail with reference to FIG. 2.

FIG. 2 is a flow chart illustrating a first embodiment of a method of the present invention. According to a first operation of the present invention, a determination that configuration of the mobile station 116 for the MMS is required (step 202). This determination may occur when the cellular wireless communication network determines that MMS subscription for the mobile station has changed, when the cellular wireless communication network determines that a server computer 124 providing the MMS for the mobile station has been altered, or when the cellular wireless communication network determines that an MMS provisioning threshold for the mobile station has been met, for example.

The method continues with provisioning a plurality of components of the cellular wireless communication network 100 for configuring the mobile station 116 (step 204). Provisioned components may include all elements of the cellular wireless communication network 100 required to establish a link between the OTAF 127 and the mobile station 116. The CSC 129, which couples to the OTAF 127, may also participate in configuring the mobile station for the MMS. Next, the method includes locating the mobile station 116 within a service area of the cellular wireless communication network 100 (step 206). With the mobile station 116 located, a servicing base station 104 and a servicing BSC 107 are also determined. Locating the mobile station 116 within a service area of the cellular wireless communication network 100 is known and is not further described herein. Components of the cellular wireless network support structure 102 required to service the configuration would include a Mobile Switching Center (MSC) and other structure that is not shown in FIG. 1 but that is generally known.

With the mobile station 116 located, the method includes establishing a wireless communication link with the mobile station 116 via the servicing base station 104 (step 208). Then, the method includes establishing communications between the OTAF 127 and the mobile station 116 via a combined wired path of the cellular wireless communication network 100 and the wireless communication link between the base station 104 and the mobile station 116 (step 210).

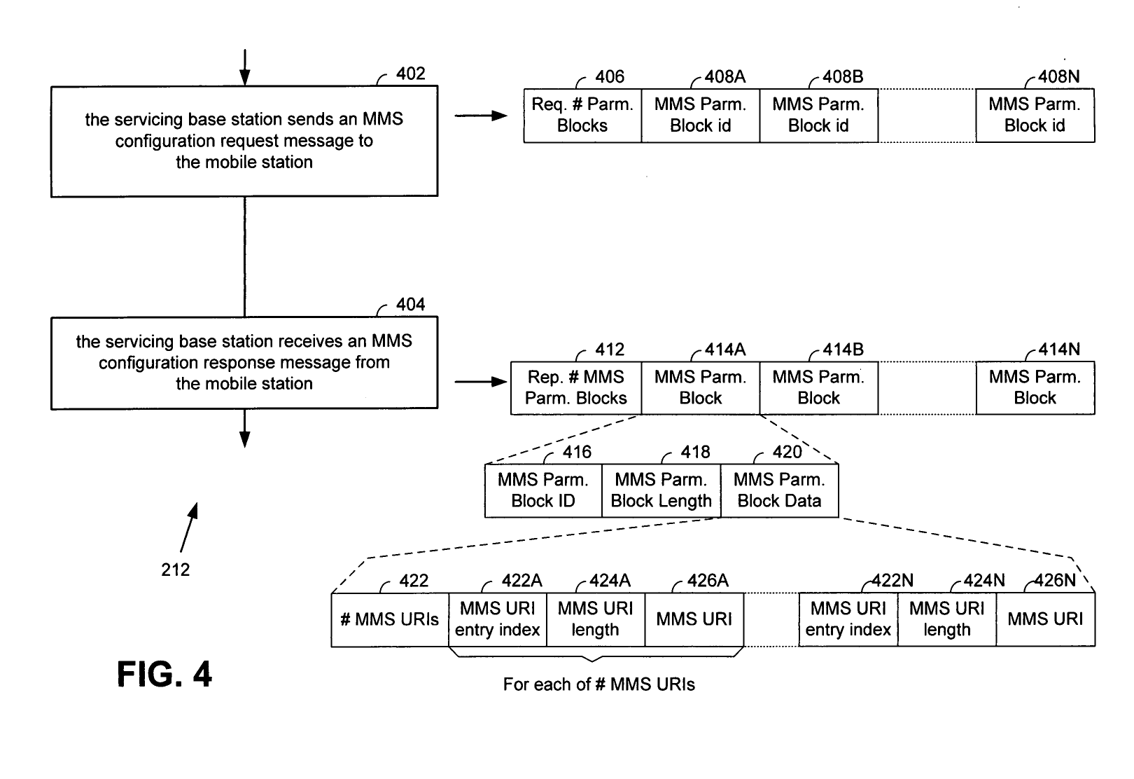

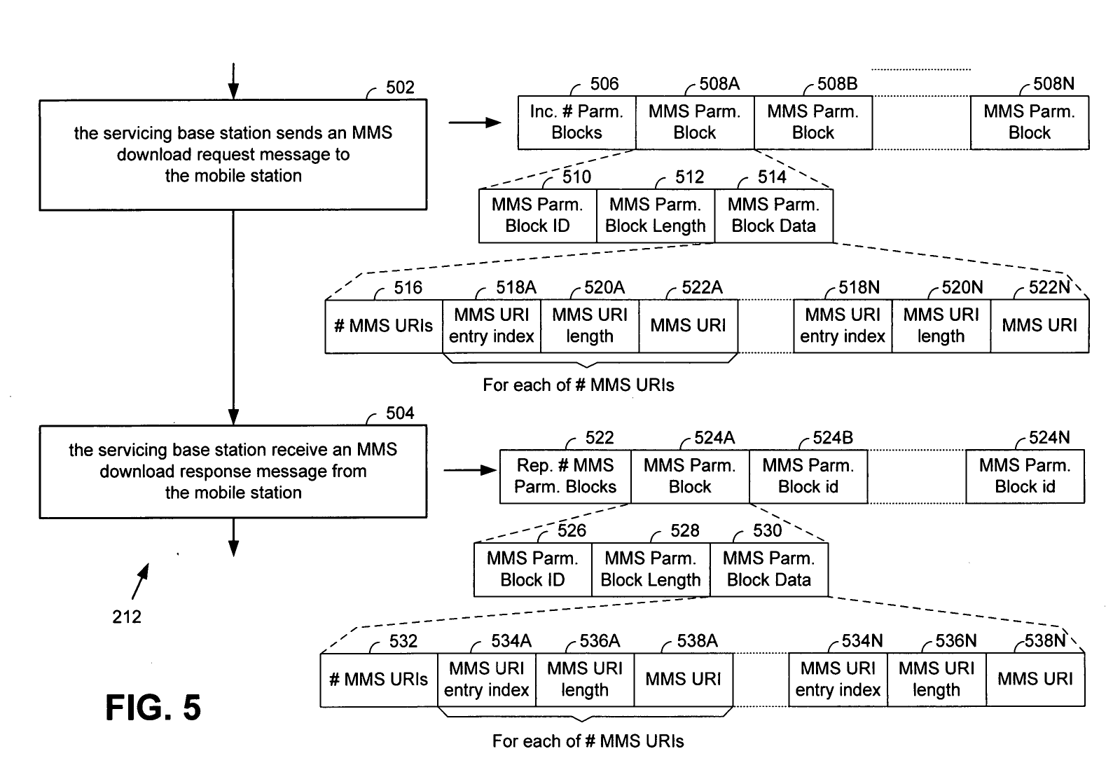

The method continues with the OTAF 127 communicating with the mobile station 116 to program at least one MMS Uniform Resource Identifier (URI) within the mobile station 116 (step 212). Once these operations are completed, the mobile station 116 is configured for MMS within the cellular wireless communication network 100. Particular details regarding step 212 of the method 200 of FIG. 2 will be described further with reference to FIGS. 4 and 5. From step 212 operation ends.

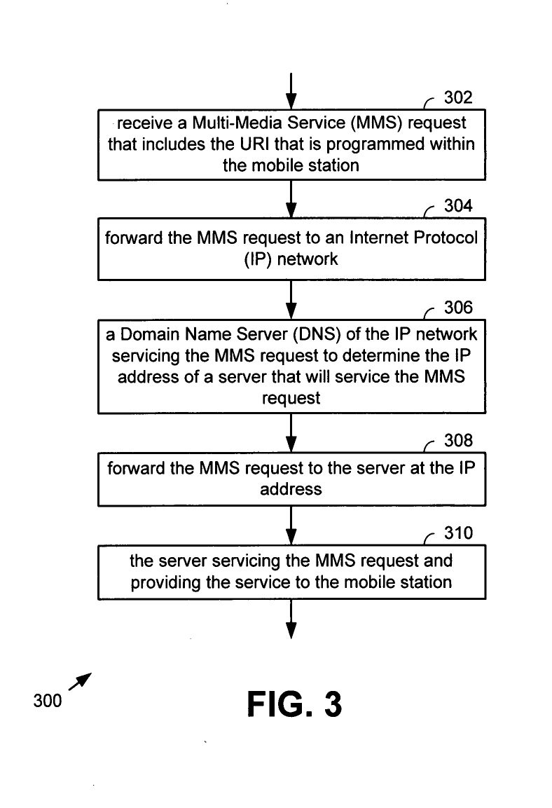

FIG. 3 is a flow chart illustrating operations according to another aspect to the present invention. Once the mobile station 116 has been configured according to the operation of FIG. 2, the cellular wireless communication network 100 may provide MMS to the mobile station 116. One example of providing the MMS includes the cellular wireless communication network 100 receiving an MMS request that includes a URI that is programmed within the mobile station 116 (step 302). The MMS request is then forwarded to an IP network (step 304). A DNS 125 of the IP network 114 services the MMS request to determine an IP address of a server 124 that will service the MMS request (step 306). The MMS request is then forwarded to the server 124 having the IP address (step 308). The server 124 then services the MMS request and provides the MMS service to the mobile station 116 via the Internet 114, gateway 112, and the cellular wireless communication network 100. This MMS may include multimedia messaging services, instant messaging services, web browsing services, audio conferencing services, or audio/video conferencing services. Of course, these examples of MMS may be expanded to include any other MMS suitable for the mobile station 116 (or another mobile station having additional/other capabilities).

FIG. 4 is a combination flow chart and block diagram illustrating a particular embodiment of the present invention. The operation of step 212 of FIG. 2 may include the servicing base station sending an MMS configuration request to the mobile station (step 402) and the servicing base station receiving an MMS configuration response from the mobile station (step 404). With this particular embodiment, the MMS configuration request message may include a requested number of MMS parameter blocks 406, and for each of the requested number of MMS parameter blocks 406, a MMS parameter block identifier 408A, 408B, . . . , 408N. Thus, the operation of step 402 via the MMS configuration request message is one in which the servicing cellular wireless communication network 100 seeks information regarding a current programming of the mobile station 116 for MMS.

With the embodiment of FIG. 4 also, the MMS configuration response message includes a reported number of MMS parameter blocks 412, and for each of the reported number of MMS parameter blocks 412, a parameter block 414A-414N. Each parameter block 414A-414N includes an MMS parameter block identifier 416, an MMS parameter block length 418, and MMS parameter block data 420. The MMS parameter block data 420 includes a corresponding number of MMS URIs 422, and for each of the corresponding number of MMS URIs 422, an MMS URI entry index 422A, a MMS URI length 424A, and an MMS URI 426A.

FIG. 5 is a combination flow chart and block diagram illustrating another particular embodiment of the present invention. According to a second embodiment of the operation of step 212 of FIG. 2, the cellular wireless communication network 100 attempts to program at least one URI within the mobile station 116 by sending an MMS download request message from the servicing base station to the mobile station (step 502). In response, the servicing base station receives an MMS download response message from the mobile station (step 504).

With this particular embodiment, the MMS download request message includes an included number of MMS parameter blocks 506 and MMS parameter blocks 508A-508N. Each MMS parameter block 508A-508N includes a MMS parameter block ID, a MMS parameter block length 512, and MMS parameter block data 514. The MMS parameter block data 514 includes a corresponding number of MMS URIs 516 and, for each of the corresponding number of MMS URIs, an MMS URI entry index 518A, an MMS URI length 520A, and an MMS URI 522A. The Nth MMS URI includes MMS URI entry index 518N, MMS URI length 520N, and MMS URI 522N.

The MMS download response message according to the embodiment of FIG. 5 includes a reported number of MMS parameter blocks 522, and a corresponding number of MMS parameter blocks 524A-524N. Each MMS parameter block 524A-524N includes an MMS parameter block identifier 526, an MMS parameter block length 528, and MMS parameter block data 530. The MMS parameter block data 530 includes a corresponding number of MMS URIs 532 and, for each of the corresponding numbers MMS URIs, an MMS URI entry index 534A, an MMS URI length 536A, and an MMS URI. Thus, the Nth MMS URI includes MMS URI entry index 534N, MMS URI length 536N, and MMS URI 538N.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

### Appendix

### Applicability of the present invention to the ANSI-683 operating standard

Terms
BS—Base Station.
OTASP—Over-the-Air Service Provisioning
MMS—Multimedia Messaging Service
MS—Mobile station.
SIP—Session Initiation Protocol
URI—Uniform Resource Identifier
UA—User Agent
   References
ANSI-683-C, Over-the-Air Service Provisioning of Mobile Stations in Spread Spectrum Standards.
X.P0016-312, “MMS MM1 Using SIP”, V&V.
X.P0016-310, “MMS MM1 Stage 3 Using OMA/WAP”, May 2003.
X.P0016-311, “MMS MM1 Stage 3 Using M-IMAP”, May 2003.
   Proposed Standard Text Changes:

The following standards contain provisions that, through reference in this text, constitute provisions of this Standard. At the time of publication, the editions indicated were valid. All standards are subject to revision, and parties to agreements based upon this Standard are encouraged to investigate the possibility of applying the most recent editions of the standards indicated below. ANSI and TIA maintain registers of currently valid national standards published by them.
1. TIA/EIA-95-B, Mobile Station-Base Station Compatibility Standard for Dual-Mode Spread Spectrum Cellular System.
2. S.S0053, “Common Cryptographic Algorithms”, January 2001.
3. S.S0054, “Interface Specification for Common Cryptographic Algorithms”, January 2002.
4. C.R1001-C “Administration of Parameter Value Assignments for cdma2000 Spread Spectrum Standards, Release C”, January 2002.
5. C.S0002-C, “Physical Layer Standard for cdma2000 Spread Spectrum Systems”, May 2002.
6. C.S0004-C, “Signaling Link Access Control (LAC) Standard for cdma2000 Spread Spectrum Systems”, May 2002.
7. C.S0005-C, “Upper Layer (Layer 3) Signaling Standard for cdma2000 Spread Spectrum Systems”, May 2002.
8. S.S0055 “Enhanced Cryptographic Algorithms, Rev. A”.
9. C.S0024, “cdma2000 High Rate Packet Data Air Interface Specification”, December 2001.
10. IETF RFC 1334, “PPP Authentication Protocols”, October 1992.
11. IETF RFC 1994, “PPP Challenge Handshake Authentication Protocol (CHAP)”, August 1996.
12. IETF RFC 2002, “IP Mobility Support”, October 1996.
13. IETF RFC 2344, “Reverse Tunneling for Mobile IP”, August 1996.
14. IETF RFC 2486, “The Network Access Interface”, January 1999.
15. IETF RFC 3012, “Mobile IPv4 Challenge/Response Extensions”, November 1999.
16. X.P0016-310, “MMS MM1 Stage 3 Using OMA/WAP”, May 2003.
17. X.P0016-311, “MMS MM1 Stage 3 Using M-IMAP”, May 2003.
18. X.P0016-312, “MMS MM1 Using SIP”, V&V.

Introduction

1.1 General Description

Over-the-Air Service Provisioning (OTASP) consists of the following features provisioned over-the-air:
Download of NAM operational parameters.
Electronic Key Exchange for securely establishing the A-key and Root Key.
System Selection for Preferred Roaming (SSPR) for providing mobile stations with information allowing acquisition of the preferred system in an area.
Preferred User Zone List (PUZL) for providing mobile stations which support the optional User Zone feature with information allowing usage of the preferred user zone in an area.
Download of 3G packet data operational parameters.

Service Programming Lock (SPL), if provided, prevents the over-the-air provisioning of certain mobile station parameters by an unauthorized network entity.

This document describes Over-the-Air Service Provisioning in CDMA and analog systems. The procedures defined are intended to be extendable and flexible enough to be used with future air interface specifications. The procedures in this document do not require support for continuation of the service provisioning process following a CDMA-to-analog handoff.

1.2 Terms and Numeric Information

1.2.1 Terms

[ . . . ]

Forward Traffic Channel. A code channel used to transport user and signaling traffic from the base station to the mobile station.

FRESH. A 15-bit value used by the mobile station and the base station as the cryptographic synchronizer for encrypting parameter data in Secure Mode. FRESH may be set by the encrypting side to any value, including a monotonically incremented counter, as long as this value is not repeated for the duration of the Secure Mode in progress.

HLR. See Home Location Register.

Home Location Register (HLR). The location register to which a MIN/IMSI is assigned for record purposes such as subscriber information.

Home System. The cellular system in which the mobile station subscribes for service.

HRPD. High Rate Packet Data. See [9].

IMSI. See International Mobile Station Identity.

IMSI_M. MIN based IMSI using the lower 10-digits to store the MIN.

IMSI_O. The operational value of IMSI used by the mobile station for operation with the base station.

IMSI_T. IMSI not associated with MIN. 15-digits or fewer.

International Mobile Station Identity (IMSI. A method of identifying stations in the land mobile service as specified in ITU-T Recommendation E.212.

Long Code Mask. A 42-bit binary number that creates the unique identity of the long code. See also Public Long Code, Private Long Code, Public Long Code Mask and Private Long Code Mask.

LSB. Least significant bit.

MCC. See Mobile Country Code.

Mobile Country Code (MCC). A part of the E.212 IMSI identifying the home country. See ITU-T Recommendation E.212. Mobile Directory Number. A dialable directory number which is not necessarily the same as the mobile station's air interface identification, i.e., MIN, IMSI_M or IMSI_T.

MIN. See Mobile Identification Number.

MMS. Multimedia Messaging Service.

MNC. See Mobile Network Code.

[ . . . ]

Over-the-Air Service Provisioning (OTASP). A process of provisioning mobile station operational parameters over the air interface.

Parity Check Bits. Bits added to a sequence of information bits to provide error detection, correction, or both.

Preferred User Zone List (PUZL). A list that provides the mobile station with the information for the User Zones to which the mobile user is subscribed.

PDSN. Packet Data Service Node.

Private Long Code. The long code characterized by the private long code mask.

Private Long Code Mask. The long code mask used to form the private long code.

Public Long Code. The long code characterized by the public long code mask.

Public Long Code Mask. The long code mask used to form the public long code. The mask contains the ESN of the mobile station. See also

Private Long Code Mask.

PUZL. See Preferred User Zone List.

Release. A process that the mobile station and base station use to inform each other of call disconnect.

Reverse CDMA Channel. The CDMA Channel from the mobile station to the base station. From the base station's perspective, the Reverse CDMA Channel is the sum of all mobile station transmissions on a CDMA frequency assignment.

Roamer. A mobile station operating in a wireless system (or network) other than the one from which service was subscribed.

Secure Mode. Network initiated mode of communicating operational parameters between a mobile station and network based provisioning entity in an encrypted form.

SIP. Session Initiation Protocol.

SMCK. Secure Mode Ciphering Key.

Service Option. A service capability of the system. Service options may be applications such as voice, data, or facsimile. See [4].

Service Programming Code (SPC). A secret code assigned to the mobile station and known to the authorized network entity.

Service Programming Lock (SPL). A protection provided for preventing the over-the-air provisioning of certain mobile station parameters by unauthorized network entity by way of verifying the Service Programming Code (SPC).

Shared Secret Data (SSD). A 128-bit pattern stored in the mobile station (in semi-permanent memory) and known by the base station. SSD is a concatenation of two 64-bit subsets: SSD_A, which is used to support the authentication procedures, and SSD_B, which serves as one of the inputs to the process generating the encryption mask and private long code.

SID. See System Identification.

[ . . . ]

1.2.2 Numeric Information

Numeric information is used to describe the operation of the mobile station. The following subscripts are used to clarify the use of the numeric information:
“s” indicates a value stored in a mobile station's temporary memory.
“r” indicates a value received by a mobile station over a forward analog control channel or a CDMA Forward Channel.
“p” indicates a value set in a mobile station's permanent security and identification memory.
“s-p” indicates a value stored in a mobile station's semi-permanent security and identification memory.

This section defines numeric information specifically related to the OTASP.

A_KEY_P_REVₚ—Protocol revision of the mobile station Key Exchange procedure.

A_KEY_TEMPₛ—A secret 64-bit pattern temporarily stored in the mobile station.

AUTH_OTAPAₛ—The computed 18-bit result AUTH_SIGNATURE used for validating SPASM.

CUR_SSPR_P_REVₛ₋ₚ—Protocol revision of the mobile station's current preferred roaming list. This information is used to parse PR_LISTₛ₋ₚ. Retained by the mobile station when the power is turned off.

DATA_P_REVₚ—Protocol revision of the mobile station NAM Download procedure.

NAM_LOCKₚ—The locking indicator set in the mobile station by the base station that defines SPASM protection of the programmable parameters in the active NAM during the OTAPA session.

NULL—A value that is not in the specified range of the field or variable.

NAM_LOCKₛ—A network controlled status of the SPASM protection of the active NAM for the subsequent OTAPA session.

NAM_LOCK_STATE—a locking state of the mobile station programmable parameters for OTAPA. If the NAM_LOCK_STATE=‘1’, the parameters are locked for network initiated programming.

PARAM_Gₛ—Key exchange parameter G.

PARAM_Pₛ—Key exchange parameter P.

PR_LISTₛ₋ₚ—Preferred Roaming List. Contains information to assist the mobile station system selection and acquisition process. Retained by the mobile station when the power is turned off.

PRL_BLOCK_ID_CURRENTₛ—Parameter Block Identifier for the current Preferred Roaming List temporarily stored in the mobile station.

PUZLₛ₋ₚ—Preferred User Zone List. Contains information to assist the mobile station during user zone selection and acquisition process. Retained by the mobile station when the power is turned off.

PUZL_P_REVₚ—Protocol revision of the mobile station PUZL Download procedure.

RAND_SEED—A secret 128-bit pattern temporarily stored in the mobile station.

RKₚ—A secret 128-bit pattern permanently stored in the mobile station.

RK_TEMPS—A secret 128-bit pattern temporarily stored in the mobile station.

SPCₚ—Service Programming Code. A secret code assigned to the mobile station and known to the authorized network entity. The base station uses the code equal to the SPCₚ for unlocking the mobile station parameters for programming or reprogramming.

SPCₛ—Service Programming Code temporarily stored in the mobile station.

SPL_P_REVₚ—Protocol revision of the mobile station Service Programming Lock.

SP_LOCK_STATE—A locking state of the mobile station programmable parameters. If the SP_LOCK_STATE=‘1’, the parameters are locked for programming.

SSPR_P_REVₚ—Protocol revision of the mobile station SSPR Download procedure and the PRL format.

SECURE_MODE_INDₛ—Secure Mode indicator. If SECURE_MODE_INDₛ=‘1’, current programming session is in Secure Mode.

SMCKₛ—Secure Mode Ciphering Key.

3.3 Programming Procedure

3.3.1 OTASP Data Message Processing

[ . . . ]

17. MMS Configuration Request Message: The mobile station shall send a MMS Configuration Response Message within 750 ms after receiving the message.
If either SP_LOCK_STATE, or NAM_LOCK_STATE, or both are set to ‘1’, the mobile station shall set the RESULT_CODE in the corresponding returned confirmation blocks to ‘00001010’, “Rejected—Mobile station locked.” The mobile station shall include all requested parameter blocks with the BLOCK_LEN field set to ‘00000000’.
If both SP_LOCK_STATE and NAM_LOCK_STATE are set to ‘O’, then:
   If the mobile station does not support a requested parameter block, the mobile station shall set RESULT_CODE in the corresponding returned confirmation block to ‘00000111’, “Rejected—BLOCK_ID value not supported.” The mobile station shall include the parameter block with the BLOCK_LEN field set to ‘00000000’.
   If the requested data blocks exceed the allowable message length, the mobile station shall set RESULT_CODE in the corresponding returned confirmation block to ‘00000000’, “Accepted—Operation successful” for each Parameter Block included in the message. The mobile station shall include data blocks, in the order requested, up to the maximum number of blocks that fit into the message.
   Otherwise, the mobile station shall set RESULT_CODE to ‘00000000’, “Accepted—Operation successful” for each Parameter Block included in the corresponding confirmation block. The mobile station shall include complete data blocks, in the order requested, in the MMS Configuration Response Message. If SECURE_MODE_INDₛ=‘1’, the mobile station shall set the FRESH_INCL field to ‘1’, and include the FRESH field and set it to a 15-bit value selected according to 3.3.8. The mobile station shall encrypt as specified in 3.3.8 each PARAM_DATA field of all Parameter Blocks included in the MMS Configuration Response Message.

18. MMS Download Request Message: The mobile station shall respond to the message with a MMS Download Response Message within 750 ms.
If FRESH_INCᵣ=‘1’, the mobile station shall set FRESH_{S}=FRESHᵣ. If the SECURE_MODE_INDₛ=‘1’, the mobile station shall decrypt as specified in 3.3.8 each PARAM_DATA field of all Parameter Blocks received in the MMS Download Request Message.
If the MMS Download Request Message contains an MMS URI Parameter Block with a BLOCK_ID that is not supported by the mobile station, the mobile station shall set BLOCK_ID to the received parameter block identifier and RESULT_CODE to ‘00000111’, “Rejected—BLOCK_ID value not supported;”
If the MMS Download Request Message contains an MMS URI Parameter Block having a size different from that supported by the mobile station, the mobile station shall set BLOCK_ID to the received parameter block identifier and RESULT_CODE to ‘00000010’, “Rejected—Data size mismatch;”
If the MMS Download Request Message contains an MMS URI Parameter Block with a parameter value that is out-of-range, the mobile station shall set BLOCK_ID to the received parameter block identifier and RESULT_CODE to ‘00000100’, “Rejected—Invalid parameter;”
If the MMS Download Request Message contains a MMS URI Parameter Block with a NUM_MMS_URI greater than that supported by the mobile station, the mobile station shall set BLOCK_ID to the received parameter block identifier and RESULT_CODE to ‘00100100’, “Rejected—NUM_MMS_URI mismatch;”
If the MMS Download Request Message contains a MMS URI Parameter Block with any MMS_URI _LENGTH larger than that supported by the mobile station, the mobile station shall set BLOCK_ID to the received parameter block identifier and RESULT_CODE to ‘00100101’, “Rejected—MMS_URI LENGTH mismatch;”
If the MMS Download Request Message contains a MMS URI Parameter Block with an invalid MMS_URI, the mobile station shall set BLOCK_ID to the received parameter block identifier and RESULT_CODE to ‘00100110’, “Rejected—MMD MAX_NUM_P-CSCF mismatch;”
If the MMS Download Request Message is not accepted for any other reason, the mobile station shall set BLOCK_ID to the received parameter block identifier and RESULT_CODE to ‘00000001’, “Rejected—Unknown reason;”
Otherwise, the mobile station shall store the message data in temporary memory, set BLOCK_ID to the received parameter block identifier and set RESULT_CODE to ‘00000000’, “Accepted—Operation successful.” If more than one MMS Download Request Message or parameter block is received containing values for the same indicators, the mobile station shall retain only the most recently received values.
   [ . . . ]

3.5 Reverse Link Message Formats

The reverse link OTASP Data Messages are summarized in Table 3.5-1.

TABLE 3.5-1
Reverse Link Messages

| Message Name | OTASP_MSG_TYPE | Reference |
|---|---|---|
| Configuration Response | ‘00000000’ | 3.5.1.1 |
| Message | | |
| Download Response Message | ‘00000001’ | 3.5.1.2 |
| MS Key Response Message | ‘00000010’ | 3.5.1.3 |
| Key Generation Response | ‘00000011’ | 3.5.1.4 |
| Message | | |
| Re-Authenticate Response | ‘00000100’ | 3.5.1.5 |
| Message | | |
| Commit Response Message | ‘00000101’ | 3.5.1.6 |
| Protocol Capability Response | ‘00000110’ | 3.5.1.7 |
| Message | | |
| SSPR Configuration Response | ‘00000111’ | 3.5.1.8 |
| Message | | |
| SSPR Download Response | ‘00001000’ | 3.5.1.9 |
| Message | | |
| Validation Response Message | ‘00001001’ | 3.5.1.10 |
| OTAPA Response Message | ‘00001010’ | 3.5.1.11 |
| PUZL Configuration Response | ‘00001011’ | 3.5.1.12 |
| Message | | |
| PUZL Download Response | ‘00001100’ | 3.5.1.13 |
| Message | | |
| 3GPD Configuration Response | ‘00001101’ | 3.5.1.14 |
| Message | | |
| 3GPD Download Response | ‘00001110’ | 3.5.1.15 |
| Message | | |
| Secure Mode Response | ‘00001111’ | 3.5.1.16 |
| Message | | |
| MMS Configuration Response | ‘00010000’ | 3.5.1.17 |
| Message | | |
| MMS Download Response | ‘00010001’ | 3.5.1.18 |
| Message | | |
| Reserved for future | ‘00010010’ through | |
| standardization | ‘10111111’ | |
| Available for manufacturer- | ‘11000000’ through | See [4] |
| specific OTASP Data Message | ‘11111110’ | |
| definition | | |
| Reserved | ‘11111111’ | |

[ . . . ]

TABLE 3.5.1.2-1
Result Codes

| RESULT_CODE | Message Parameter Description |
|---|---|
| ‘00000000’ | Accepted - Operation successful |
| ‘00000001’ | Rejected - Unknown reason |
| ‘00011010’ | Rejected - MobileIP MAX_MN- |
| | HA_SS_LENGTH mismatch |
| ‘00011011’ | Rejected - MobileIP MN- |
| | AAA_AUTH_ALGORITHM mismatch |
| ‘00011100’ | Rejected - MobileIP MN- |
| | HA_AUTH_ALGORITHM mismatch |
| ‘00011101’ | Rejected - SimpleIP ACT_NAI_ENTRY_{—} |
| | INDEX mismatch |
| ‘00011110’ | Rejected - MobileIP ACT_NAI_ENTRY_{—} |
| | INDEX mismatch |
| ‘00011111’ | Rejected - SimpleIP PAP NAI_ENTRY_{—} |
| INDEX | mismatch |
| ‘00100000’ | Rejected - SimpleIP CHAP |
| | NAI_ENTRY_INDEX mismatch |
| ‘00100001’ | Rejected - MobileIP NAI_ENTRY_INDEX |
| | mismatch |
| ‘00100010’ | Rejected - Unexpected PRL_BLOCK_ID |
| | change |
| ‘00100011’ | Rejected - PRL format mismatch |
| ‘00100100’ | Rejected - NUM_MMS_URI mismatch |
| ‘00100101’ | Rejected - MMS_URI_LENGTH mismatch |
| ‘00100110’ | Rejected - Invalid MMS_URI |
| ‘00100111’-‘01111111’ | Reserved for future standardization |
| ‘10000000’-‘11111110’ | Available for manufacturer-specific Result |
| | Code definitions. See [4]. |
| ‘11111111’ | Reserved |

[ . . . ]

TABLE 3.5.1.7-1
Feature Identifier

| | | | FEATURE_P_REV |
|---|---|---|---|
| Features | FEATURE_ID | FEATURE_P_REV | Description |
| NAM Download | ‘00000000’ | ‘00000010’ | NAM Download as |
| (DATA_P_REV) | | | specified in this |
| | | | document |
| Key Exchange | ‘00000001’ | ‘00000010’ | A key provisioning as |
| (A_KEY_P_REV) | | | specified in this |
| | | | document |
| | | ‘00000011’ | A key and 3G Root Key |
| | | | provisioning as |
| | | | specified in this |
| | | | document |
| | | ‘00000100’ | 3G Root Key |
| | | | provisioning as |
| | | | specified in this |
| | | | document |
| System Selection for | ‘00000010’ | ‘00000001’ | System Selection for |
| Preferred Roaming | | | Preferred Roaming |
| (SSPR_P_REV) | | | using Preferred |
| | | | Roaming List |
| | | ‘00000010’ | Reserved |
| | | ‘00000011’ | System Selection for |
| | | | Preferred Roaming |
| | | | using Extended |
| | | | Preferred Roaming List |
| | | | associated with |
| | | | SSPR_P_REV of |
| | | | ‘00000011’ |
| [ . . . ] | [ . . . ] | [ . . . ] | [ . . . ] |
| Over-The-Air Parameter | ‘00000100’ | ‘00000001’ | Over-The-Air Parameter |
| Administration | | | Administration as |
| (OTAPA_P_REV) | | | specified in this |
| | | | document |
| Preferred User Zone | ‘00000101’ | ‘00000001’ | Preferred User Zone |
| List | | | List as specified in this |
| (PUZL_P_REV) | | | document |
| 3G Packet Data (3GPD) | ‘00000110’ | ‘00000010’ | 3G Packet Data as |
| | | | specified in this |
| | | | document |
| Secure MODE | ‘00000111’ | ‘00000001’ | Secure Mode as |
| SECURE_MODE_P_REV) | | | specified in this |
| | | | document |
| Multimedia Messaging | ‘00001000’ | ‘00000001’ | MMS as specified in |
| Service (MMS) | | | this document |
| Reserved for future | ‘000001001’ | | |
| standardization | through | | |
| | ‘10111111’ | | |
| Available for | ‘11000000’ | See [4] | |
| manufacturer-specific | through | | |
| features | ‘11111110’ | | |
| Reserved | ‘11111111’ | | |

3.5.1.17 MMS Configuration Response Message

The MMS Configuration Response Message has the following variable-length format:

| Field | Length (bits) |
|---|---|
| OTASP_MSG_TYPE (‘00010000’) | 8 |
| NUM_BLOCKS | 8 |

NUM_BLOCKS occurrences of the following parameter block:

| | |
|---|---|
| BLOCK_ID | 8 |
| BLOCK_LEN | 8 |
| PARAM_DATA | 8 × BLOCK_LEN |
| FRESH_INCL | 1 |
| FRESH | 0 or 15 |
| RESERVED | 0 or 7 |

OTASP_MSG_TYPE —OTASP Data Message type.
   The base station shall set this field to ‘00010000’.
NUM_BLOCKS—Number of parameter blocks.
   The base station shall set this field to the number of parameter blocks contained in the MMS Configuration Response Message.
BLOCK_ID—Parameter block identifier.
   The base station shall set this field to the value of the parameter block type being included in the message (see Table 3.5.9-1).
BLOCK_LEN—Parameter block length.
   The base station shall set this field to the number of octets in the parameter block, not including the BLOCK_ID and BLOCK_LEN fields.
PARAM_DATA—Parameter data fields.
   The base station shall include the parameter block specified by the BLOCK_ID field. If Secure Mode is active (see 4.3.5), PARAM_DATA fields shall be encrypted as specified in 4.3.5.
FRESH_INCL—FRESH included indicator.
   If Secure Mode is active (See 4.3.5), the base station shall set this field to ‘1’; otherwise the base station shall set this field to ‘0’.
FRESH—Cryptographic Synchronizer (crypto-sync) selected for encrypting PARAM_DATA fields of the message.

If FRESH_INCL=‘1’, the base station shall include this field and set it to a 15-bit value chosen as specified in 4.3.5 for encrypting the PARAM_DATA fields of all Parameter Data blocks included in the message; otherwise the base station shall omit this field.
RESERVED—Reserved bits.
   If FRESH_INCL=‘1’, the base station shall omit this field; otherwise, the base station shall set all the bits of this field to ‘0’.
      [ . . . ]
      3.5.1.18 MMS Download Response Message

The MMS Download Response Message has the following variable-length format:

| Field | Length (bits) |
|---|---|
| OTASP_MSG_TYPE (‘00001110’) | 8 |
| NUM_BLOCKS | 8 |

NUM_BLOCKS occurrences of the following confirmation block:

| | |
|---|---|
| BLOCK_ID | 8 |
| RESULT_CODE | 8 |

OTASP_MSG_TYPE—OTASP Data Message type.
   The mobile station shall set this field to ‘00010001’.
NUM_BLOCKS—Number of parameter blocks.
   The mobile station shall set this field to the number of parameter blocks contained in the MMS Download Request Message that is being confirmed.

The mobile station shall set NUM_BLOCKS occurrences of the following fields:
BLOCK_ID—Parameter block identifier.
   The mobile station shall set this field to the value of the BLOCK_ID field of the corresponding parameter block in the MMS Download Request Message that is being confirmed (see Table 4.5.8-1).
RESULT_CODE—Download result code.
   The mobile station shall set this field to indicate acceptance or rejection status of the corresponding parameter block in the MMS Download Request Message that is being confirmed, using the values defined in Table 3.5.1.2-1.
      [ . . . ]
      3.5.9 MMS Parameter Block

Table 3.5.9-1 lists the types of parameter blocks used in the MMS Configuration Request Message and the MMS Configuration Response Message.

TABLE 3.5.9-1
MMS Parameter Block Types

| Parameter Block Type | BLOCK_ID | Reference |
|---|---|---|
| MMS URI Parameters | ‘00000000’ | 3.5.9.1 |
| Reserved | ‘00000001’ | |
| | through | |
| | ‘11111111’ | |

3.5.9.1 MMS URI Parameters

The PARAM_DATA field of the MMS URI Parameters Block consists of the following fields:

| Field | Length (bits) |
|---|---|
| NUM_MMS_URI | 4 |

NUM_MMS_URI occurrences of the following fields:

| | |
|---|---|
| MMS_URI_ENTRY_IDX | 4 |
| MMS_URI_LENGTH | 8 |
| MMS URI | 8 × MMS_URI_LENGTH |
| RESERVED | 0 to 7 |

NUM_MMS_URI—Number of MMS URIs
   The mobile station shall set this field to the number of MMS URIs stored on the mobile, encoded in ASCII string, refer to [16], [17],[18].

The mobile station shall include NUM_MMS_URI occurrences of the following fields:
MMS_URI_ENTRY_IDX—MMS URI entry index.
   The mobile station shall set this field to the index in the MMS URI Table.
MMS_URI_LENGTH—MMS URI length.
   The mobile station shall set this field to the length of the URI associated with the MMS Relay/Server in units of octet
MMS_URI—MMS_URI
   The mobile station shall set this field to the URI of the MMS Relay/Server, encoded in ASCII string, refer to [16][17][18]
RESERVED—Reserved bits.
   The mobile station shall add reserved bits as needed in order to make the length of the entire parameter block equal to an integer number of octets.
      [ . . . ]

4.3 Programming Data Download

4.3.1 OTA Data Message Processing

[ . . . ]

17. MMS Configuration Request Message: The base station should wait for a MMS Configuration Response Message.

18. MMS Download Request Message: The base station should wait for a MMS Download Response Message.

[ . . . ]

TABLE 4.5-1
Forward Link Messages

| Message Name | OTASP_MSG_TYPE | Reference |
|---|---|---|
| Configuration Request | ‘00000000’ | 4.5.1.1 |
| Message | | |
| Download Request Message | ‘00000001’ | 4.5.1.2 |
| MS Key Request Message | ‘00000010’ | 4.5.1.3 |
| Key Generation Request | ‘00000011’ | 4.5.1.4 |
| Message | | |
| Re-Authenticate Request | ‘00000100’ | 4.5.1.5 |
| Message | | |
| Commit Request Message | ‘00000101’ | 4.5.1.6 |
| Protocol Capability Request | ‘00000110’ | 4.5.1.7 |
| Message | | |
| SSPR Configuration Request | ‘00000111’ | 4.5.1.8 |
| Message | | |
| SSPR Download Request | ‘00001000’ | 4.5.1.9 |
| Message | | |
| Validation Request Message | ‘00001001’ | 4.5.1.10 |
| OTAPA Request Message | ‘00001010’ | 4.5.1.11 |
| PUZL Configuration Request | ‘00001011’ | 4.5.1.12 |
| Message | | |
| PUZL Download Request | ‘00001100’ | 4.5.1.13 |
| Message | | |
| 3GPD Configuration Request | ‘00001101’ | 4.5.1.14 |
| Message | | |
| 3GPD Downloaded Request | ‘00001110’ | 4.5.1.15 |
| Message | | |
| Secure Mode Request | ‘00001111’ | 4.5.1.16 |
| Message | | |
| MMS Configuration Request | ‘00010000’ | 4.5.1.17 |
| Message | | |
| MMS Download Request | ‘00010001’ | 4.5.1.18 |
| Message | | |
| Reserved for future | ‘00010010’ through | |
| standardization | ‘10111111’ | |
| Available for manufacturer- | ‘11000000’ through | See [4] |
| specific OTASP Data | ‘11111110’ | |
| Message definition | | |
| Reserved | ‘11111111’ | |

[ . . . ]
4.5.1.17 MMS Configuration Request Message

The MMS Configuration Request Message has the following format:

| Field | Length (bits) |
|---|---|
| OTASP_MSG_TYPE (‘00010000’) | 8 |
| NUM_BLOCKS | 8 |

NUM_BLOCKS occurrences of the following fields:

| | |
|---|---|
| BLOCK_ID | 8 |

OTASP_MSG_TYPE—OTASP Data Message type.
   The base station shall set this field to ‘00010000’.
NUM_BLOCKS—Number of parameter blocks requested.
   The base station shall set this field to the number of parameter blocks requested.

The base station shall include NUM_BLOCKS occurrences of the following field:
BLOCK_ID—Parameter block identifier.

The base station shall set this field to the value of the BLOCK_ID of the parameter block being requested in this message (see Table 3.5.9-1).

4.5.1.18 MMS Download Request Message

The MMS Download Request Message has the following variable-length format:

| Field | Length (bits) |
|---|---|
| OTASP_MSG_TYPE (‘00010001’) | 8 |
| NUM_BLOCKS | 8 |

NUM_BLOCKS occurrences of the following parameter block:

| | |
|---|---|
| BLOCK_ID | 8 |
| BLOCK_LEN | 8 |
| PARAM_DATA | 8 × BLOCK_LEN |
| FRESH_INCL | 1 |
| FRESH | 0 or 15 |
| RESERVED | 0 or 7 |

OTASP_MSG_TYPE—OTASP Data Message type.
   The base station shall set this field to ‘00010001’.
NUM_BLOCKS—Number of parameter blocks.
   The base station shall set this field to the number of parameter blocks contained in the MMS Download Request Message.
BLOCK_ID—Parameter block identifier.
   The base station shall set this field to the value of the parameter block type being included in the message (see Table 4.5.8-1).
BLOCK_LEN—Parameter block length.
   The base station shall set this field to the number of octets in the parameter block, not including the BLOCK_ID and BLOCK_LEN fields.
PARAM_DATA—Parameter data fields.
   The base station shall include the parameter block specified by the BLOCK_ID field. If Secure Mode is active (see 4.3.5), PARAM_DATA fields shall be encrypted as specified in 4.3.5.
FRESH_INCL—FRESH included indicator.
   If Secure Mode is active (See 4.3.5), the base station shall set this field to ‘1’; otherwise the base station shall set this field to ‘0’.
FRESH—Cryptographic Synchronizer (crypto-sync) selected for encrypting PARAM_DATA fields of the message.

If FRESH_INCL=‘1’, the base station shall include this field and set it to a 15-bit value chosen as specified in 4.3.5 for encrypting the PARAM_DATA fields of all Parameter Data blocks included in the message; otherwise the base station shall omit this field.
RESERVED—Reserved bits.
   If FRESH_INCL=‘1’, the base station shall omit this field; otherwise, the base station shall set all the bits of this field to ‘0’.
      4.5.8 MMS Parameter Block

Table 4.5.8-1 lists the types of parameter blocks used in the MMS Download Request Message and the MMS Download Response Message.

TABLE 4.5.8-1
MMS Parameter Block Types

| Parameter Block Type | BLOCK_ID | Reference |
|---|---|---|
| MMS URI Parameters | ‘00000000’ | 4.5.8.1 |
| Reserved | ‘00000001’ | |
| | through | |
| | ‘11111111’ | |

4.5.8.1 MMS URI Parameters

The PARAM_DATA field of the MMS Application URI Block consists of the following fields:

| Field | Length (bits) |
|---|---|
| NUM_MMS_URI | 4 |

NUM_MMS_URI occurrences of the following fields:

| | |
|---|---|
| MMS_URI_ENTRY_IDX | 4 |
| MMS_URI_LENGTH | 8 |
| MMS URI | 8 × MMS_URI_LENGTH |
| RESERVED | 0 to 7 |

NUM_MMS_URI—Number of MMS URIs
   The mobile station shall set this field to the number of MMS URIs stored on the mobile, encoded in ASCII string, refer to [16][17],[18].

The mobile station shall include NUM_MMS_URI occurrences of the following fields:
MMS_URI_ENTRY_IDX—MMS URI entry index.
   The mobile station shall set this field to the index in the MMS URI Table.
MMS_URI_LENGTH—MMS URI length.
   The mobile station shall set this field to the length of the URI associated with the MMS Relay/Server in units of octet
MMS_URI—MMS_URI
   The mobile station shall set this field to the URI of the MMS Relay/Server, encoded in ASCII string, refer to [16],[17],[18].
RESERVED—Reserved bits.
   The mobile station shall add reserved bits as needed in order to make the length of the entire parameter block equal to an integer number of octets.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method for operating a cellular wireless communication network to configure a mobile station to support a Multi-Media Service (MMS), the method comprising:
determining that configuration of the mobile station for the MMS is required;
provisioning a plurality of components of the cellular wireless communication network for configuring the mobile station, the plurality of components of the cellular wireless communication network including an Over-The-Air-Function (OTAF);
locating the mobile station;
establishing a wireless communication link with the mobile station via a servicing base station;
establishing communications between the OTAF and the mobile station via a combination of a wired path of the cellular wireless communication network and the wireless communication link; and
the OTAF communicating with the mobile station to program at least one MMS Uniform Resource Identifier (URI) within the mobile station.

2. The method of claim 1, wherein the MMS includes at least one of:
multimedia messaging services;
instant messaging services;
web browsing services;
audio conferencing services; and
audio/video conferencing services.

3. The method of claim 1, further comprising:
receiving a Multi-Media Service (MMS) request that includes the URI that is programmed within the mobile station;
forwarding the MMS request to an Internet Protocol (IP) network;
a Domain Name Server (DNS) of the IP network servicing the MMS request to determine the IP address of a server that will service the MMS request;
forwarding the MMS request to the server at the IP address; and
the server servicing the MMS request and providing the service to the mobile station.

4. The method of claim 1, wherein the OTAF communicating with the mobile station to program at least one Uniform Resource Identifier (URI) within the mobile station comprises:
the servicing base station sending an MMS configuration request message to the mobile station; and
the servicing base station receiving an MMS configuration response message from the mobile station.

5. The method of claim 4, wherein the MMS configuration request message comprises:
a requested number of MMS parameter blocks;
for each of the requested number of MMS parameter blocks, an MMS parameter block identifier.

6. The method of claim 4, wherein the MMS configuration response message comprises:
a reported number of MMS parameter blocks; and
for each of the reported number of MMS parameter blocks:
an MMS parameter block identifier;
an MMS parameter block length; and
MMS parameter block data.

7. The method of claim 6, wherein the MMS parameter block data comprises:
a corresponding number of MMS URIs; and
for each the corresponding number of MMS URIs:
a MMS URI entry index;
a MMS URI length; and
a MMS URI.

8. The method of claim 1, wherein the OTAF communicating with the mobile station to program at least one Uniform Resource Identifier (URI) within the mobile station comprises:
the servicing base station sending an MMS download request message to the mobile station; and
the servicing base station receiving an MMS download response message from the mobile station.

9. The method of claim 8, wherein the MMS download request message comprises:
an included number of MMS parameter blocks; and
for each of the included number of MMS parameter blocks:
an MMS parameter block identifier;
an MMS parameter block length; and
MMS parameter block data.

10. The method of claim 9, wherein the MMS parameter block data comprises:
a corresponding number of MMS URIs; and
for each the corresponding number of MMS URIs:
a MMS URI entry index;
a MMS URI length; and
a MMS URI.

11. The method of claim 9, wherein the MMS download response message comprises:
a reported number of MMS parameter blocks; and
for each of the reported number of MMS parameter blocks:
an MMS parameter block identifier;
an MMS parameter block length; and
MMS parameter block data.

12. The method of claim 11, wherein the MMS parameter block data comprises:
a corresponding number of MMS URIs; and
for each the corresponding number of MMS URIs:
a MMS URI entry index;
a MMS URI length; and
a MMS URI.

13. The method of claim 1, wherein determining that configuration of the mobile station for the MMS is required occurs when:
the cellular wireless communication network determines that MMS subscription for the mobile station has changed;
the cellular wireless communication network determines that a server computer providing the MMS for the mobile station has been altered; or
the cellular wireless communication network determines that a MMS provisioning threshold for the mobile station has been met.

14. A method for operating a cellular wireless communication network to configure a mobile station to support a Multi-Media Service (MMS), the method comprising:
locating the mobile station;
establishing a wireless communication link with the mobile station via a servicing base station; and
the servicing base station sending a MMS configuration request message to the mobile station that includes:
a requested number of MMS parameter blocks; and
for each of the number of MMS parameter blocks requested, a MMS parameter block identifier; and
the servicing base station receiving a MMS configuration response message from the mobile station that includes
a reported number of MMS parameter blocks; and
for each of the reported number of MMS parameter blocks:
a MMS parameter block identifier;
a MMS parameter block length; and
MMS parameter block data.

15. The method of claim 14, wherein the MMS parameter block data comprises:
a corresponding number of MMS URIs; and
for each the corresponding number of MMS URIs:
a MMS URI entry index;
a MMS URI length; and
a MMS URI.

16. The method of claim 14, further comprising:
the servicing base station sending an MMS download request message to the mobile station that includes:
a number of MMS parameter blocks; and
for each of the number of number of MMS parameter blocks:
a MMS parameter block identifier;
a MMS parameter block length; and
MMS parameter block data; and
the servicing base station receiving an MMS download response message from the mobile station that includes:
a reported number of MMS parameter blocks; and
for each of the reported number of MMS parameter blocks:
an MMS parameter block identifier;
an MMS parameter block length; and
MMS parameter block data.

17. The method of claim 14, wherein the MMS includes at least one of:
multimedia messaging services;
instant messaging services;
web browsing services;
audio conferencing services; and
audio/video conferencing services.

18. The method of claim 14, further comprising:
receiving a Multi-Media Service (MMS) request that includes the URI that is programmed within the mobile station;
forwarding the MMS request to an Internet Protocol (IP) network;
a Domain Name Server (DNS) of the IP network servicing the MMS request to determine the IP address of a server that will service the MMS request;
forwarding the MMS request to the server at the IP address; and
the server servicing the MMS request and providing the service to the mobile station.

19. A method for operating a cellular wireless communication network to configure a mobile station to support a Multi-Media Service (MMS), the method comprising:
locating the mobile station;
establishing a wireless communication link with the mobile station via a servicing base station;
the servicing base station sending an MMS download request message to the mobile station that includes:
a number of MMS parameter blocks; and
for each of the number of number of MMS parameter blocks:
a MMS parameter block identifier;
a MMS parameter block length; and
MMS parameter block data; and
the servicing base station receiving an MMS download response message from the mobile station that includes:
a reported number of MMS parameter blocks; and
for each of the reported number of MMS parameter blocks:
an MMS parameter block identifier;
an MMS parameter block length; and
MMS parameter block data.

20. The method of claim 19, wherein the MMS parameter block data comprises:
a corresponding number of MMS URIs; and
for each the corresponding number of MMS URIs:
a MMS URI entry index;
a MMS URI length; and
a MMS URI.
